(19) United States
(12) Patent Application Publication
(10) Pub. No.: US 2002/0145531 A1
(43) Pub. Date: Oct. 10, 2002

(54) Container lid alarm

(76) Inventor: Scot Delaney, Thomasville, GA (US)

Correspondence Address: Brian D. Bellamy, P.O. Box 1997, Thomasville, GA, 31799, US

(21) Appl. No.: 09/816,037

(22) Filed: Mar. 22, 2001

(51) Int. Cl. G08B 21/00

(52) U.S. Cl. 340/689; 340/686.1; 340/690; 340/547; 340/545.6

(57) ABSTRACT

A self-contained alarm unit contained withing a housing may be attached to a container lid or door to provide a signal when the lid or door is opened. A magnet within the housing rests on a sloped track and moves to activate the alarm signal by causing a switch to close.

### BACKGROUND OF THE INVENTION

Unfortunately, theft from tool boxes and the like is a common occurrence because these containers cannot be monitored by their owner at all times. Sometimes, the owner of a container for storage of items like tools, fishing lures, and jewelry must leave the container while working, eating, or concentrating on other activities.

For instance, construction workers or auto mechanics often drive pick-up trucks having unlocked tool chests in the cargo bed. These persons will often leave their vehicle unattended while working, and theft sometimes occurs by passers by and sometimes by co-workers. Anyone who considers the contents of an unlocked storage container valuable may be tempted to open the container and take some of its contents in hope of not being caught. The odds of catching the would be thief are diminished when only one or two items are taken from a container holding many items.

Thus, a need exists for a compact alarm that may be conveniently attached to a storage container, such as a tool box, and that will notify the owner of the container if the container is opened. Further, a portable alarm is needed that can be quickly adapted to a variety of containers that could benefit from an indicator that the container's lid has been opened. Containers that could benefit from such a device include tool boxes, tackles boxes, jewelry cases, and strong boxes.

### SUMMARY OF THE INVENTION

The present invention provides a small self-contained alarm unit that addresses the need for a simple device to prevent theft by taking out of storage containers. The present alarm unit includes a housing. An adherent backing on the housing enables the alarm unit to be attached to the inside of a container lid. The backing may consist of an adherent means such as an adhesive strip or velcro. The alarm unit is configured with an adherent backing and a battery operated electrical circuit to make the unit portable and easily adaptable to a variety of container lids.

Further, the compact alarm unit includes an activating arrangement that is motion sensitive. The activating arrangement includes a magnetic disk that resides on a track such that the disk moves along the track from a seated position to an activating position. When the alarm unit is placed on a container lid and the lid is closed, the magnetic disk remains in the seated position. However, the track is sloped so that when someone opens the lid to the container, the slope changes to allow the force of gravity to move the magnetic disk along the track to the activating position. In the activating position the magnetic disk causes a magnet sensitive circuit to close and send the necessary electrical signal to activate the alarm. Thus, the alarm unit is sensitive to the opening of the container lid and will activate when the lid is opened.

### DESCRIPTION OF DRAWINGS

FIG. 1 is a front elevational view of the self-contained alarm unit of the present invention.

FIG. 2 is a rear elevational view of the self-contained alarm unit of the present invention.

FIG. 3 is a cut-away view of the present invention showing the arrangement of internal components of the present invention.

FIG. 4 is a perspective view of a box having a closed lid and employing the present invention therein.

FIG. 5 is a perspective view of the box of FIG. 4 having an open lid and employing the present invention as an alarm indicating the open status of the lid.

FIG. 6 is a cut-away view of the alarm unit showing the position of the magnet in a seated position while the alarm unit is in a horizontal position as on the closed lid of the box in FIG. 4.

FIG. 7 is a cut-away view of the alarm unit showing the position of the magnet in an activation position while the alarm unit is in a vertical position as on the open lid of the box in FIG. 5.

### DETAILED DESCRIPTION OF INVENTION

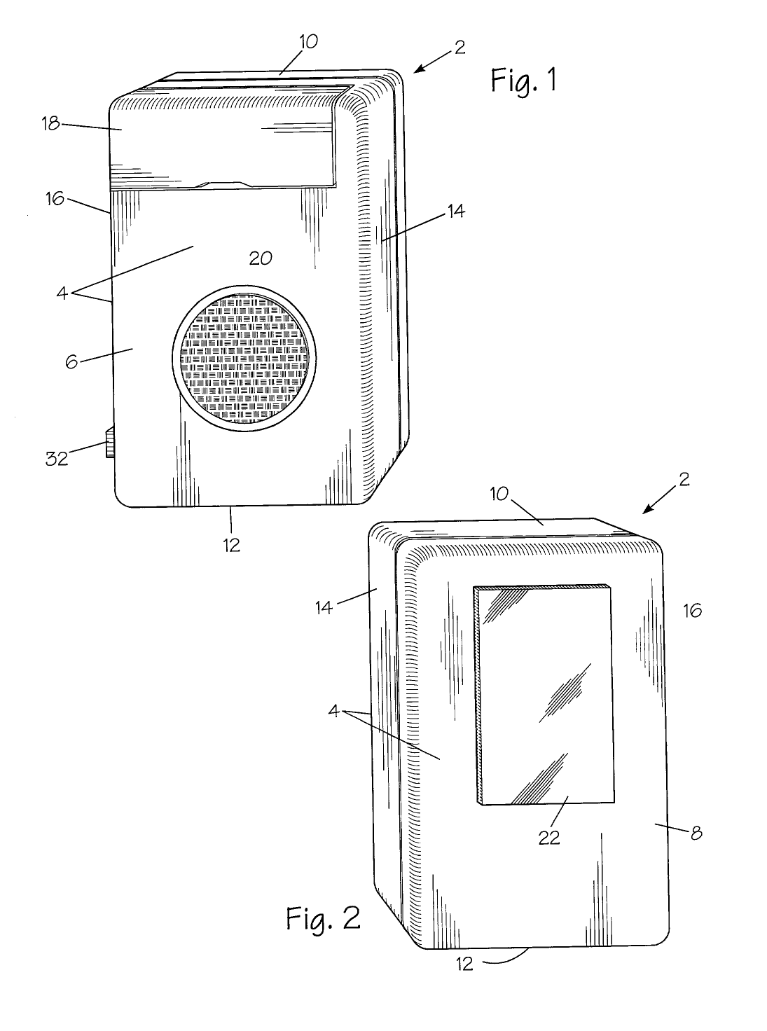

Referring now to the drawings, a preferred embodiment of the invention is shown. As depicted in FIG. 1, the invention comprises a self-contained alarm unit 2 that is encased by a housing 4. The housing may be of any shape that will retain the components therein that are required by the invention. As shown, the housing is box shaped and, accordingly, has several surfaces that include a front face 6, and back 8 that are separated by an opposing top 10 and bottom 12, as well as an opposing first side 14 and second side 16. Regardless of the desired shape of the housing, round, oval, square, rectangular, or otherwise, the preferred housing is compact. The compact alarm unit 2 provided by the overall design of the device enhances the portability and versatility of the alarm unit 2. The housing 4 includes a battery compartment 18 and signaling device 20, and, in the particular embodiment of FIG. 1, these features are situated on the front surface 6.

As illustrated in FIG. 2, an adherent backing 22 is affixed on the back 8 of the housing 4 to temporarily attach the alarm unit 2 to a surface such as the underside 24 of a container lid 26 of a container 27. In the drawings, FIG. 4 and FIG. 5 illustrate the placement of the alarm unit 2 on the container lid 26. The adherent backing 22 may be an adhesive material or some alternative such as velcro, a magnet or a hanging device, but should be sufficiently adherent to secure the alarm unit 2 to the lid 26 until removed by manual force. Since the alarm unit 2 provides distinct advantages because of its portability and ability to be used in diverse situations, the adherent backing 22 should not join the alarm unit 2 to the lid 26 such that the alarm unit is difficult to remove. Thereby, a single alarm unit 2 may be used with a number of containers 27 such as a tool box or a tackle box. The alarm unit 2 could even be used for child proofing containers presenting dangerous or fragile situations such as with a gun case or musical instrument case.

To provide power for the self-contained alarm unit 2, a battery such as a typical 9-volt battery is contained within the housing 4 in the battery compartment 18. Battery contacts 28 connect the battery to the remainder of the electrical circuitry, including the circuit board 30. The battery may be easily tested by tilting the alarm unit 2 to simulate the opening of a lid 26 and determining whether the battery provides sufficient power to activate the alarm unit 2. A number of alternative options for the alarm signal that results from activation may be provided in the design of the alarm unit 2 depending on various needs. FIG. 1 illustrates the signaling device 20 includes a speaker that sounds an audible signal if the alarm unit 2 is activated. However, it is recognized by the inventor that using various devices for providing an audible signal such as a buzzer or bell would not detract from the purpose of the invention to provide a versatile portable alarm unit 2 for container covers. Variations of such signal devices are considered within the scope of the disclosed embodiment.

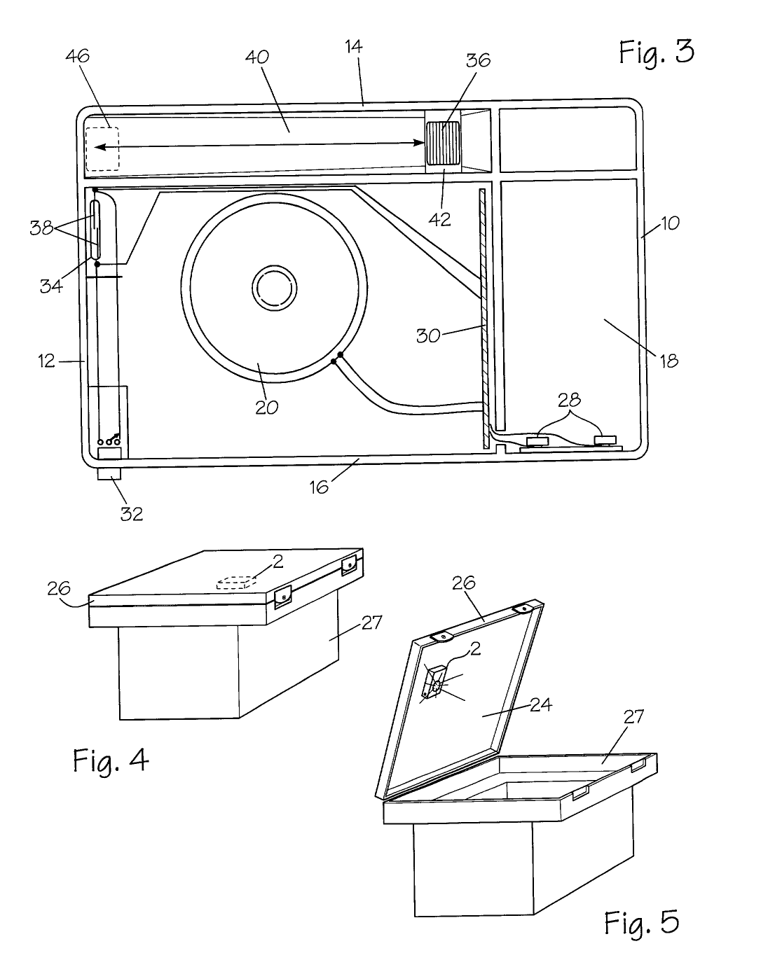

When the external on/off switch 32 is turned on, the alarm unit 2 remains deactivated until activated by closing a switch 34. The alarm unit 2 in the present invention is designed to activate in accordance with the opening of a container 27 having a lid 26 that opens by raising or lowering. Therefore, the present invention provides for closing the switch 34 when opening a container lid 26 to which the alarm unit 2 is attached. This occurs by the movement of a magnet 36 into close proximity to the switch 34 as shown in FIG. 3. The switch 34 includes two conductive contacts 38 that are composed of a magnetic metal. As the magnet 36 moves into close proximity to the contacts 38, the contacts are drawn together to complete the electric circuit that is connected to the signaling device 20, battery contacts 28, circuit board 30 and switch 34.

The magnet 36 illustrated in the preferred embodiment is generally round and flat such that the magnet 36 is cylindrically shaped or disk shaped. However, magnets that are thicker or even spherical may also perform acceptably as described herein. In particular, for the magnet 36 to activate the switch 34, the magnet 36 must be moved by the force of gravity into close proximity of the switch 34 and must be a magnet 36 having sufficient magnetic force to close the contacts 38 when in the close proximity caused by such movement.

The magnet 36 moves along a track 40 as illustrated in FIGS. 3, 6, and 7. As shown in FIGS. 3 and 6, the magnet 36 begins in a first position in which the magnet 36 rests is a seated position 42. In the example shown, a recess 44 is provided at the seated position 42 that provides a means to bias the magnet 36 to remain in the seated position 42.

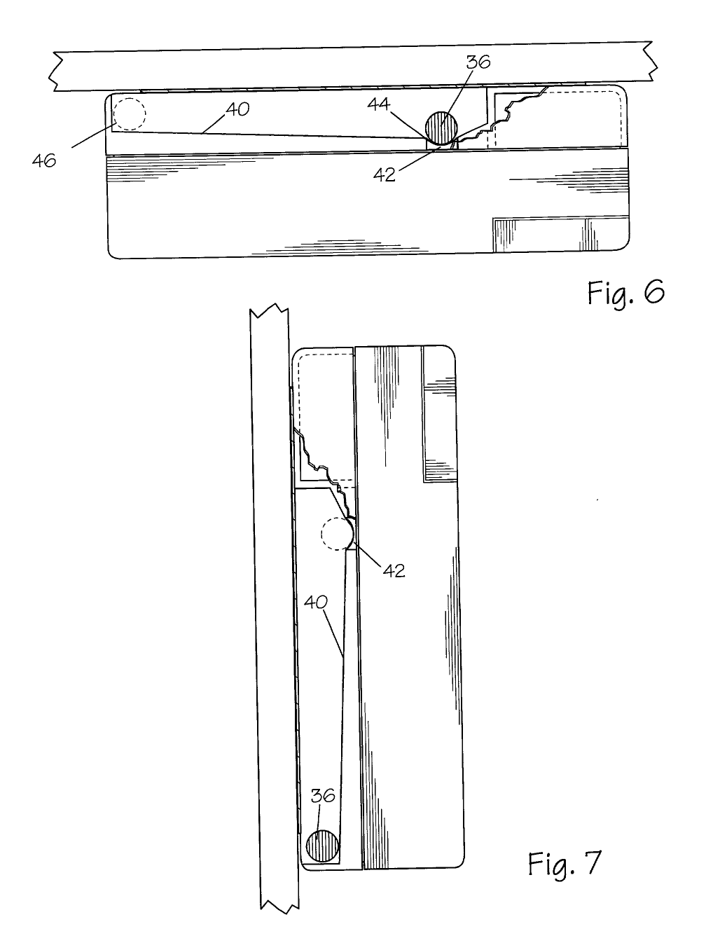

The magnet 36 is caused to leave the seated position 42 when gravitational forces on the magnet 36 cause the magnet to overcome the bias the seated position 42 and begin moving by rolling or sliding on the track 40. The track 40 is sloped such that the track 40 slopes downward toward the seated position 42 when the alarm unit 2 is oriented with the magnet 36 intended to rest in the seated position 42 with the alarm unit 2 in a deactivated position. Generally, the alarm unit 2 will be oriented horizontally with the magnet 36 in the seated position 42, as shown in FIG. 6, while on a closed container lid 26. In the horizontal and deactivated position, the angle of slope of track 40 toward the seated position 42 will be between about 5 degrees to 60 degrees. As the alarm unit 2 is oriented vertically as shown in FIG. 7, the angle of slope of the track is reoriented toward the switch 34. Thus, the magnet 36 overcomes bias of remaining in the seated position 42 and moves on the track 40 by the downward forces of gravity into a second position on the opposite end of the track 40 from the seated position 42 in which the magnet rests into an activation position 46 that is in close proximity to the switch 38.

Therefore, as illustrated in FIG. 4, when the container lid 26 is closed, the alarm unit 2 is deactivated as the alarm unit 2 is oriented horizontally and the magnet 36 is in the seated position 42 as shown in FIG. 6. While, as illustrated in FIG. 5, when the container lid 26 is open, the alarm unit 2 is activated as the alarm unit 2 is oriented near vertically and the magnet 36 is in the activation position 46 as shown in FIG. 7. A variation that would be advantageous in some circumstances would be for the alarm unit 2 to be reconfigured by changing the orientation of the track 40 such that the unit 2 would remain deactivated when oriented vertically and would activate when moved into a more horizontal orientation. This particular reconfiguration would be advantageous where a container lid is oriented vertically when closed and with the container lid opens up into a horizontal position when opened.

From the foregoing description of the illustrative embodiments of the invention, it will be apparent that many modifications may be made. The embodiments described exemplify the invention, and the invention is not limited thereto. Therefore, it is intended that the claims are to cover all such modifications that fall within the true spirit and scope of the invention.

I claim:

1. A self-contained alarm unit comprising:
a. a housing;
b. a signaling device contained within the housing;
c. a switch contained within the housing connected to said signaling device by an electrically conductive circuit;
d. a sloped track contained within the housing;
e. a magnet contained within the housing that rests on the sloped track in a first seated position in which the alarm unit is deactivated and moves along said track to a second activation position in which the alarm unit is activated by closing said switch;
f. a battery compartment contained within the housing;
g. an adherent device attached to the housing.

2. A self-contained alarm unit as set forth in claim 1 in which said switch includes conductive contacts that close when said magnet is in said second activation position.

3. A self-contained alarm unit as set forth in claim 1 in which said adherent device is an adhesive backing.

4. A self-contained alarm unit as set forth in claim 1 in which said adherent device is a magnet.

5. A self-contained alarm unit as set forth in claim 1 in which said track slopes at an angle of descent of 5 degrees to 60 degrees while said magnet is in said first seated position.

6. A self-contained alarm unit as set forth in claim 1 in which said magnet is biased to remain in said first seated position by a recess in said sloped track.

7. A self-contained alarm unit as set forth in claim 1 in which said signaling device provides an audible alarm signal.

8. A self-contained alarm unit as set forth in claim 1 in which said signaling device provides a light emitting alarm signal.

9. A self-contained alarm unit as set forth in claim 1 in which said signaling device transmits a signal to a receiver.
